(19) United States
(12) Patent Application Publication
(10) Pub. No.: US 2017/0210337 A1
(43) Pub. Date: Jul. 27, 2017

(54) BUCKLE DEVICE

(71) Applicant: KABUSHIKI KAISHA TOKAI-RIKA-DENKI-SEISAKUSHO, Aichi-ken (JP)

(72) Inventor: Makoto MATSUZAKI, Aichi-ken (JP)

(21) Appl. No.: 15/410,176

(22) Filed: Jan. 19, 2017

(30) Foreign Application Priority Data
Jan. 22, 2016 (JP) 2016-010972

(51) Int. Cl. B60R 22/20; A44B 11/25; H02K 7/14; B60R 22/22

(52) U.S. Cl. CPC B60R 22/20; B60R 22/22; A44B 11/2561; H02K 7/14; B60R 2022/1806

(57) ABSTRACT

The buckle device is provided with two wire ropes disposed side by side along a seat width direction. An inside wall face of a wire guide groove of a wire guide at which the two wire ropes pass is configured as a face parallel to the seat width direction. This enables a difference to be suppressed from occurring between magnitudes of reaction forces from the inside wall face of the wire guide groove of the wire guide received by one and another of the wire ropes due to the wire ropes being pulled toward their length direction leading end side.

### CROSS-REFERENCE TO RELATED APPLICATION

This application claims priority under 35 USC 119 from Japanese Patent Application No. 2016-010972 filed Jan. 22, 2016, the disclosure of which is incorporated by reference herein.

### BACKGROUND

Field of the Invention

The present invention relates to a buckle device that is capable of moving a buckle by driving a drive section.

Related Art

Buckle devices exist in which a movement section configured by a wire or the like is moved along the length direction of the movement section by drive force of a drive section, and a buckle provided at a length direction leading end portion of the movement section is moved accordingly (see, for example, Japanese Patent Application Laid-Open (JP-A) No. 2015-44460).

In such buckle devices, a length direction intermediate portion of the movement section is bent by an intermediate member such as a bend section. Thus, when the movement section is pulled toward its length direction leading end side, the intermediate member bears (received) load from a bent portion of the length direction intermediate portion of the movement section. Note that the magnitude of load from the movement section borne by the intermediate member sometimes varies according to the position of the intermediate member where the load from the movement section is borne, and a variation sometimes occurs in reaction force from the intermediate member borne by the movement section according to the abutting position of the movement section on the intermediate member.

### SUMMARY

In consideration of the above circumstances, a buckle device capable of suppressing a difference from occurring in reaction forces from an intermediate member received by a movement section according to an abutting position of the movement section on the intermediate member is obtained.

A buckle device of a first aspect includes: a buckle that is configured to engage with a tongue of a seatbelt device; a movement section whose leading end portion in a length direction of the movement section is coupled to the buckle, and that is configured to move along the length direction accompanying the buckle; a drive section that is driven such that the movement section is moved along the length direction; and an intermediate member at which an intermediate portion in the length direction of the movement section is bent, and that is capable of suppressing a difference from occurring between curvatures of bending of the intermediate portion at one side and at another side of the movement section in a seat width direction of a seat applied with the seatbelt device, when the movement section abuts the intermediate member.

The buckle device of the first aspect can suppress a difference from occurring between curvatures of bending of the intermediate portion at one side and at another side of the movement section at the intermediate member in a seat width direction of a seat applied with the seatbelt device, when the movement section abuts the intermediate member. This enables a difference to be suppressed from occurring between reaction forces received from the intermediate member at the one side in the seat width direction and the another in the seat width direction of the movement section when the buckle is pulled toward the seat front side of the seat, for example.

For example, in the first aspect, it is possible that when the intermediate portion abuts the intermediate member, the curvatures of the bending of the intermediate portion at the one side and at the another side are the same.

A buckle device of a second aspect is the buckle device of the first aspect of the present invention, wherein: the movement section includes a plurality of moving members disposed side by side in the seat width direction; and the intermediate member is capable of suppressing a difference from occurring between curvatures of bendings of the plurality of moving members at the intermediate member when the plurality of moving members abut the intermediate member.

In the buckle device of the second aspect, the movement section includes the plural moving members arrayed (disposed side by side) in the seat width direction. The intermediate member is capable of suppressing a difference from occurring between the curvatures of bendings of the plural moving members at the intermediate member when the moving members abut the intermediate member. This enables a difference to be suppressed from occurring between reaction forces received from the intermediate member at length direction intermediate portions of the respective moving members when the buckle is pulled toward the seat front side of the seat, for example.

For example, in the second aspect, it is possible that when intermediate portions of the plurality of moving members abut the intermediate member, the curvatures of the bendings of the intermediate portions at the intermediate member are the same.

A buckle device of a third aspect is the buckle device of the first aspect or the second aspect of the present invention, wherein an inside wall face at the intermediate member, provided at an inner side of a bent portion of the intermediate portion, is parallel to the seat width direction.

In the buckle device of the third aspect, the inside wall face at the intermediate member, provided at the inner side of the bent portion of the intermediate portion, is parallel to the seat width direction. Thus, for example, the length direction intermediate portion of the movement section abuts the inside wall face of the intermediate member, and the length direction intermediate portion of the movement section is bent so as to follow the inside wall face of the intermediate member. This enables a difference to be suppressed from occurring between curvatures of bending of the length direction intermediate portion of the movement section at the one side and the another side of the movement section in the seat width direction of the seat.

A buckle device of a fourth aspect is the buckle device of any one of the first aspect to the third aspect of the present invention, wherein: the intermediate member includes a groove portion that is open in the seat width direction, and the intermediate portion is bent due to the intermediate portion being disposed at an inside of the groove portion; the groove portion includes the inside wall face; and an outside wall face of the groove portion, provided at an outer side of the bent portion of the intermediate portion, is sloped toward the outer side with respect to an opening direction of the groove portion.

In the buckle device of the fourth aspect, the intermediate member includes the groove portion that is open in the seat width direction, and the length direction intermediate portion of the movement section is bent around and disposed at the inside wall face of the groove portion of the intermediate member. Note that the outside wall face of the groove portion, provided at the outer side of the bent portion of the intermediate portion, is sloped toward the outer side with respect to an orientation toward an opening side (the opening direction) of the groove portion. This facilitates removal (opening) of a mold member for forming the intermediate member.

As explained above, the buckle device according to the aspects is capable of suppressing a difference from occurring in reaction forces from the intermediate member received by the movement section according to the abutting position of the movement section and the intermediate member.

### BRIEF DESCRIPTION OF THE DRAWINGS

Exemplary embodiments will be described in detail with reference to the following figures, wherein:

FIG. 1 is a side view of a seat applied with a buckle device according to an exemplary embodiment of the present invention, as viewed from the vehicle width direction inside;

FIG. 2 is a side cross-section of a buckle device according to an exemplary embodiment of the present invention with a cover plate removed;

FIG. 3 is an enlarged side view of a cover plate of a buckle device according to an exemplary embodiment of the present invention and the vicinity thereof;

FIG. 4 is an enlarged side view of a wire guide of a buckle device according to an exemplary embodiment of the present invention and the vicinity thereof; and

FIG. 5 is a cross-section sectioned along line 5-5 in FIG. 3.

### DETAILED DESCRIPTION

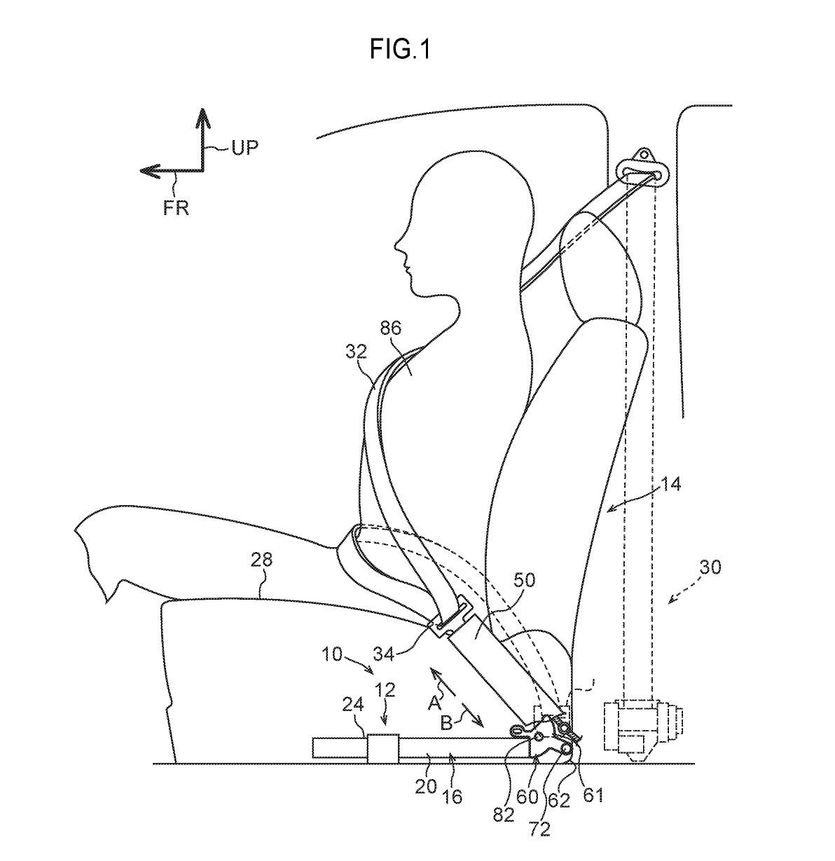

Explanation follows regarding an exemplary embodiment, based on FIG. 1 to FIG. 5. Note that in each of the drawings, the arrow FR indicates the vehicle front side, the arrow OUT indicates the vehicle width direction outside, and the arrow UP indicates the vehicle upper side of a location where a buckle device 10 is applied.

Configuration of Present Exemplary Embodiment

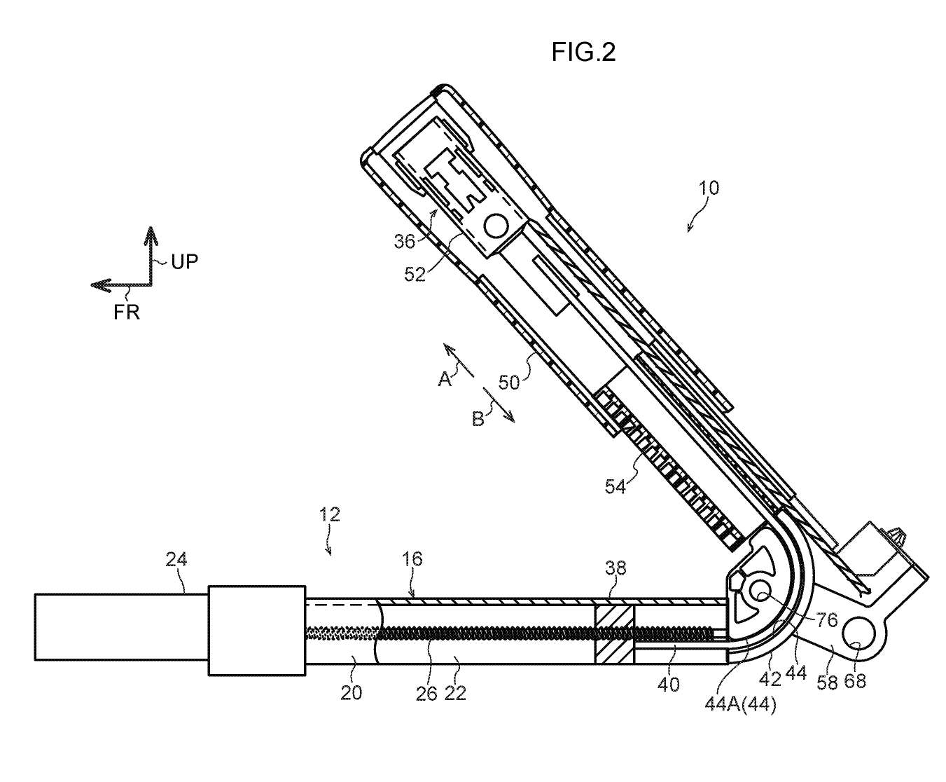

As illustrated in FIG. 1, the buckle device 10 includes a buckle drive device 12 serving as a drive section. The buckle drive device 12 is provided at the vehicle width direction inside of a seat 14 applied with the buckle device 10. The buckle drive device 12 includes a guide rail 16 serving as a slider guiding mechanism. The guide rail 16 is fixed to the vehicle body side, such as a floor section of the vehicle body of the vehicle, by a fastener such as a bolt. As illustrated in FIG. 2, the guide rail 16 includes a pair of guide walls 20 and 22 that face each other in the vehicle width direction and serve as slider guiding section. A drive screw 26 serving as a drive member is provided between the guide walls 20 and 22. The central axial direction of the drive screw 26 extends along the vehicle front-rear direction, and the drive screw 26 is capable of rotating about its central axis.

A motor actuator 24, serving as a drive force output unit, is provided at the vehicle front side of the guide rail 16. A vehicle front side end portion of the drive screw 26 is coupled to the motor actuator 24, and the drive screw 26 is rotated about the central axis of the drive screw 26 by drive force output from a motor of the motor actuator 24. The motor actuator 24 is electrically connected to a controller (not illustrated in the drawings) such as a motor driver or an ECU. The controller is electrically connected to a detector, such as a door opening and closing detector such as a courtesy switch that detects opening and closing of a vehicle door corresponding to the seat 14 applied with the buckle device 10, and/or an occupant detector such as a load sensor provided to a seat cushion 28 of the seat 14. The controller is also electrically connected to a buckle switch (also not illustrated in the drawings) that detects when a tongue 34 provided to webbing 32 of a seatbelt device 30 illustrated in FIG. 1 has engaged with a buckle 36 (see FIG. 2) of the buckle device 10, described later. The motor actuator 24 is controlled based on electrical signals output from the detector, such as the door opening and closing detector, the occupant detector, the buckle switch, and the like.

As illustrated in FIG. 2, a slider 38 is provided between the guide wall 20 and the guide wall 22 of the guide rail 16. The slider 38 is formed in a block shape. As illustrated in FIG. 2, vehicle width direction side faces of the slider 38 abut the guide walls 20 and 22 of the guide rail 16. A thread hole which the drive screw 26 pierces through is formed in the slider 38. The slider 38 is guided by the guide walls 20 and 22 so as to slide along the vehicle front-rear direction due to the drive screw 26 rotating.

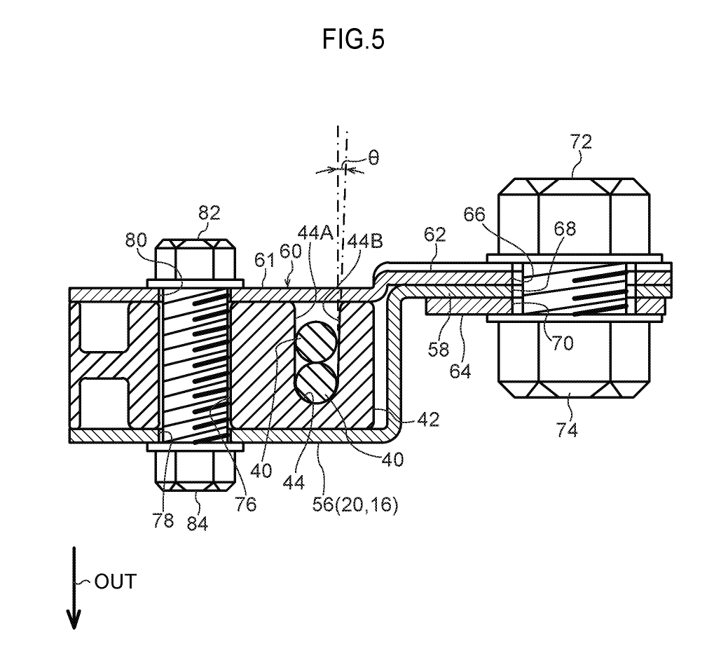

As illustrated in FIG. 2, the buckle device 10 includes two wire ropes 40 serving as moving member configuring a movement section (one of the wire ropes 40 corresponds to the movement section at one side, and another of the wire ropes 40 corresponds to the movement section at another side). The wire ropes 40 are each formed in an elongated shape, and, as illustrated in FIG. 5, are provided side by side in the vehicle width direction (the width direction of the seat 14). As illustrated in FIG. 2, at the side of the wire ropes 40 that is further toward respective base ends than length direction intermediate portions thereof, the length direction of the wire ropes 40 runs along the vehicle front-rear direction, and respective length direction base end portions of the wire ropes 40 are coupled to the slider 38 at a location further toward the vehicle lower side than the drive screw 26. Thus, the wire ropes 40 are moved along their length direction when the slider 38 slides along the vehicle front-rear direction.

A wire guide 42 serving as an intermediate member is provided at the vehicle rear side of the guide rail 16. A wire guide groove 44 serving as a groove portion (abut portion) is formed in the wire guide 42. The wire guide groove 44 is open at an inside face in the vehicle width direction of the wire guide 42. One end of the wire guide groove 44 in a length direction thereof is open at a vehicle front side face of the wire guide 42, an intermediate portion of the wire guide groove 44 in the length direction thereof is curved about an axis, an axial direction thereof being along the vehicle width direction, and another end of the wire guide groove 44 in the length direction thereof is open at a vehicle upper side face of the wire guide 42. The wire ropes 40 are passed through the wire guide groove 44. The wire ropes (intermediate portions) 40 are bent (curved) (so, bent portions (curved portions) are formed) around an axis, an axial direction thereof being along the vehicle width direction (the width direction of the seat 14), so as to follow the wire guide groove 44 of the wire guide 42. The wire ropes 40, that are further toward the respective leading ends than the opening at the vehicle upper side face of the wire guide 42, extend diagonally toward the vehicle upper front side (see the arrow A direction in FIG. 2).

Note that an inside wall face 44A at the wire guide groove 44 of the wire guide 42, this inside wall face 44A being a wall face disposed at the inner side of the bent portions of the wire ropes 40 (at the inner side of bend-curve of the wire ropes 40 in FIG. 2) (namely, the inside wall face 44A is located at a side of center-of-curvature of bending of the bent portions of the wire ropes 40 with respect to the wire ropes 40), configures a face that is parallel to the vehicle width direction (the width direction of the seat 14). In contrast thereto, an outside wall face 44B at the wire guide groove 44 of the wire guide 42, this being a wall face disposed at the outer side of the bent portions of the wire ropes 40 (at the outer side of bend-curve of the wire ropes 40 in FIG. 2) (namely, the outside wall face 44A is located at the opposite side of the wire ropes 40 from the center-of-curvature of bending of the bent portions of the wire ropes 40), is sloped at a specific angle θ toward the outer side of the bent portions of the wire ropes 40 (toward the side opposite to the center-of-curvature side) with respect to the open direction side of the wire guide groove 44 (inside of the vehicle width direction).

The buckle device 10 includes a buckle cover 50. The buckle cover 50 has a tube shape with its length direction in directions (the arrow A direction and the arrow B direction in FIG. 2) sloping in the vehicle front-rear direction with respect to the vehicle up-down direction. The buckle 36 is provided in a vehicle upper side portion inside the buckle cover 50. The buckle 36 includes a buckle body 52. The buckle body 52 is formed with a U-shaped cross-section profile open toward the vehicle width direction outside. Configuration components (not illustrated in the drawings) of the buckle 36, such as a latch, are provided inside the buckle body 52. When the tongue 34 provided at the webbing 32 of the seatbelt device 30 illustrated in FIG. 1 is inserted diagonally into the buckle body 52 from the vehicle upper front side of the buckle body 52, the latch provided at the buckle body 52 enters a hole portion formed in the tongue 34, and the tongue 34 engages with the buckle 36 accordingly.

As illustrated in FIG. 2, the buckle device 10 includes a buckle guide 54. The buckle guide 54 is formed using a synthetic resin material that is softer than the buckle cover 50. The buckle guide 54 has a long tube shape running along the length direction of the buckle cover 50 (the arrow A direction and the arrow B direction in FIG. 2). A portion of the of the buckle guide 54 that is diagonally at the vehicle lower rear side is coupled to the guide rail 16. The buckle guide 54 is inserted into the buckle cover 50 from an end portion of the buckle cover 50 that is diagonally at the vehicle lower rear side. The buckle cover 50 is thereby capable of moving diagonally toward the vehicle upper front side (the arrow A direction in FIG. 2) and diagonally toward the vehicle lower rear side (the arrow B direction in FIG. 2) guided by the buckle guide 54.

The wire ropes 40 are passed through inside the buckle guide 54. The leading end side in the length direction of the wire ropes 40 extends from an end portion that is diagonally at the vehicle upper front side of the buckle guide 54 toward the outside of the buckle guide 54, and is coupled to the buckle body 52 provided to the buckle cover 50. Thus, when the leading end portions in the length direction of the wire ropes 40 are moved diagonally toward the vehicle upper front side (the arrow A direction in FIG. 2) due to the wire ropes 40 being moved toward their length direction leading end side, the buckle 36 is moved diagonally toward the vehicle upper front side accompanying the buckle cover 50. In contrast thereto, when the leading end portions in the length direction of the wire ropes 40 are moved diagonally toward the vehicle lower rear side (the arrow B direction in FIG. 2) due to the wire ropes 40 being moved toward their length direction base end side, the buckle 36 is moved diagonally toward the vehicle lower rear side accompanying the buckle cover 50.

As illustrated in FIG. 5, an extension tab 56 extending out from a vehicle rear side end portion of the guide wall 20 of the guide rail 16 is disposed at the vehicle width direction outside of the above-described wire guide 42. The extension tab 56 is bent toward the vehicle width direction inside at the vehicle rear side of the wire guide 42. A guide rail fixing tab 58 illustrated in FIG. 5 extends out diagonally toward the vehicle lower rear side from a vehicle width direction inside end portion of a part of the extension tab 56, which part is bent toward the vehicle width direction inside.

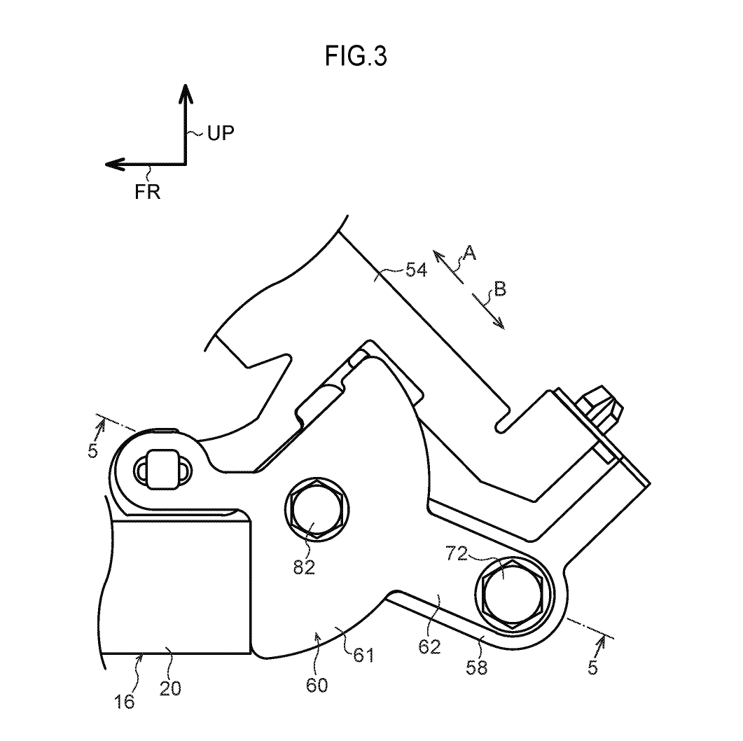

As illustrated in FIG. 1 and FIG. 3, a cover plate 60 serving as a coupling member is provided at the vehicle width direction inside of the wire guide 42. The cover plate 60 is provided with a cover plate main body 61 serving as a second coupling section. The wire guide groove 44 of the wire guide 42 is closed off from the vehicle width direction inside by the cover plate main body 61 of the cover plate 60. As illustrated in FIG. 3, the cover plate 60 is provided with a cover plate fixing tab 62 serving as a first coupling section. The cover plate fixing tab 62 extends out diagonally toward the vehicle lower rear side from the cover plate main body 61 of the cover plate 60. The cover plate fixing tab 62 of the cover plate 60 faces the guide rail fixing tab 58 at the vehicle width direction inside of the guide rail fixing tab 58 of the guide rail 16. As illustrated in FIG. 5, a support plate 64, which is provided at the floor section of the vehicle body of the vehicle, is disposed at the vehicle width direction outside of the guide rail fixing tab 58 of the guide rail 16.

A cover plate first hole portion 66 is formed in the cover plate fixing tab 62 of the cover plate 60, a guide rail fixing tab hole portion 68 is formed in the guide rail fixing tab 58 of the guide rail 16, and a support plate hole portion 70 is formed in the support plate 64 of the floor section of the vehicle body of the vehicle. The cover plate first hole portion 66, the guide rail fixing tab hole portion 68, and the support plate hole portion 70 all face in the vehicle width direction. A first fixing member (bolt) 72 is disposed piercing through the cover plate first hole portion 66, the guide rail fixing tab hole portion 68, and the support plate hole portion 70. A first nut 74 is screwed onto a leading end portion of the first fixing bolt 72. The cover plate fixing tab 62 of the cover plate 60 and the guide rail fixing tab 58 of the guide rail 16 are thereby fixed to the support plate 64 of the floor section of the vehicle body of the vehicle.

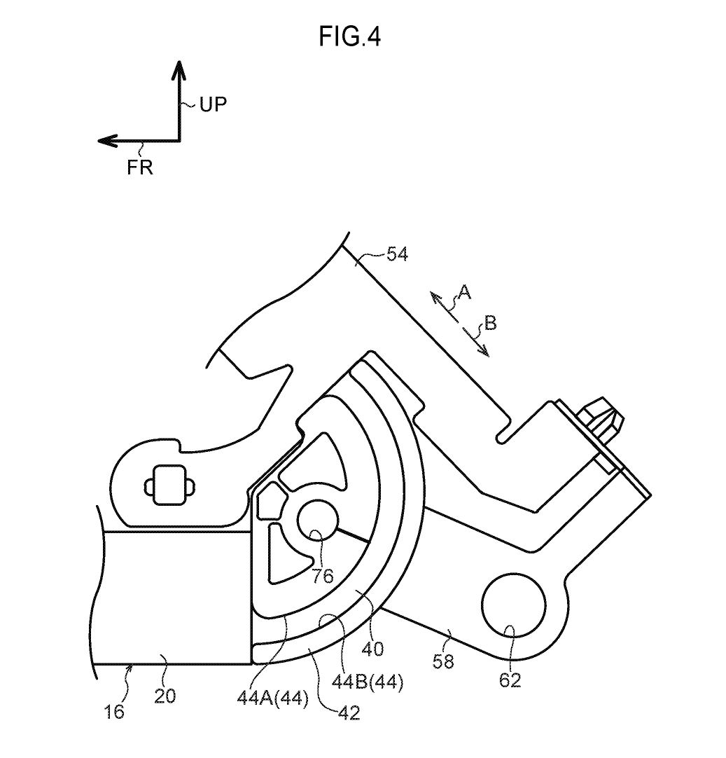

As illustrated in FIG. 4, a wire guide hole portion 76 is formed in a portion of the wire guide 42, the portion is at further toward the inside in the direction of the radius of curvature of the wire guide groove 44 than the wire guide groove 44. As illustrated in FIG. 5, the wire guide hole portion 76 of the wire guide 42 pierces through in the vehicle width direction. The above-described extension tab 56 of the guide rail 16 is disposed at the vehicle width direction outside of the wire guide hole portion 76 of the wire guide 42. An extension tab hole portion 78 is formed in the extension tab 56. The extension tab hole portion 78 of the extension tab 56 faces the wire guide hole portion 76 of the wire guide 42 in the vehicle width direction. A cover plate second hole portion 80, formed in the cover plate main body 61 of the cover plate 60, faces the wire guide hole portion 76 at the vehicle width direction inside of the wire guide hole portion 76 of the wire guide 42.

As illustrated in FIG. 5, a second fixing member (bolt) 82 is disposed piercing through the wire guide hole portion 76 of the wire guide 42, the extension tab hole portion 78 of the extension tab 56 of the guide rail 16, and the cover plate second hole portion 80 of the cover plate 60. A second nut 84 is screwed onto a leading end portion of the second fixing bolt 82. Thus, the wire guide 42 is fixed to the cover plate 60 and the extension tab 56 of the guide rail 16, and further the wire guide 42 is fixed, via the cover plate 60 and the extension tab 56 of the guide rail 16, to the support plate 64 provided at the floor section of the vehicle body of the vehicle.

Operation and Advantageous Effects of Present Exemplary Embodiment

In the buckle device 10, when the vehicle door corresponding to the seat 14 applied to the buckle device 10 is changed from a closed state to an open state, for example, this change in the open and closed states of the door is detected by a detector such as a door opening and closing detector such as a courtesy switch. When an occupant 86 then sits on the seat 14, for example, this seating of the occupant 86 on the seat 14 is detected by a detector such as an occupant detector such as a load sensor provided at the seat cushion 28 of the seat 14 or the like. The level of electrical signal(s) output from the detector(s) to the controller is changed by the change in the state of the door and/or the seat 14 accompanying the occupant boarding the vehicle in this manner. When the motor actuator 24 is accordingly driven to rotate the drive screw 26, the slider 38 is guided by the guide walls 20 and 22 of the guide rail 16 and slides toward the vehicle rear side. When the wire ropes 40 are accordingly moved toward their length direction leading end side, the buckle body 52 is pressed diagonally toward the vehicle upper front side by the wire ropes 40.

When pressing force from the wire ropes 40 is transmitted to the buckle cover 50 through the buckle body 52, then, as illustrated in FIG. 2, the buckle cover 50 is guided by the buckle guide 54 and moved diagonally toward the vehicle upper front side (the arrow A direction side in FIG. 2). Due to the buckle cover 50 being moved in this manner, the occupant 86 can easily engage the tongue 34 with the buckle 36, and can easily put on the webbing 32.

When the tongue 34 engages with the buckle 36, the level of electrical signal output from the buckle switch of the buckle 36 to the controller changes. When the motor actuator 24 is accordingly driven to rotate the drive screw 26, the slider 38 is guided by the guide walls 20 and 22 of the guide rail 16 and slides toward the vehicle front side. When the wire ropes 40 are moved toward their length direction base end side accordingly, the buckle cover 50 is pulled through the buckle body 52 by the wire ropes 40. Thus, the buckle cover 50 is guided by the buckle guide 54, and, as illustrated in FIG. 1, the buckle cover 50 is moved diagonally toward the vehicle lower rear side (the arrow B direction in FIG. 3).

When the vehicle suddenly decelerates during a vehicle collision or the like, the webbing 32 that is worn on the body of the occupant 86 seated in the seat 14 is pulled by the body of the occupant 86. When the buckle 36 of the buckle device 10 is accordingly pulled diagonally toward the vehicle upper front side by the tongue 34 provided at the webbing 32, the length direction leading end side of the wire ropes 40 coupled to the buckle 36 of the buckle device 10 are also pulled diagonally toward the vehicle upper front side.

When the length direction leading end side of the wire ropes 40 is pulled diagonally toward the vehicle upper front side in this manner, the side of the wire ropes 40, that is further toward the length direction base end than the wire guide 42, is pulled toward the vehicle rear side. However, the length direction base end portions of the wire ropes 40 are retained by the slider 38, and so movement of the length direction base end portions of the wire ropes 40 toward the vehicle rear side is prevented. Thus, reaction force against the pulling force applied to the length direction leading end side of the wire ropes 40 acts on the length direction base end portions of the wire ropes 40. In this state, the inside wall face 44A of the wire guide groove 44 of the wire guide 42 is pressed by the wire ropes 40.

Note that in the present exemplary embodiment, the two wire ropes 40 are arrayed (are disposed side by side) in the vehicle width direction (the width direction of the seat 14). Moreover, the inside wall face 44A of the wire guide groove 44 of the wire guide 42 is parallel to the vehicle width direction (the width direction of the seat 14). Thus, both wire ropes 40 have the same curvature of bending of bent portions when both wire ropes 40 bend (curves) so as to follow the inside wall face 44A of the wire guide groove 44, due to both wire ropes 40 abutting the inside wall face 44A of the wire guide groove 44 of the wire guide 42.

Thus, both wire ropes 40 have the same durability against reaction force applied from the inside wall face 44A of the wire guide groove 44 of the wire guide 42, and the reaction force applied to one wire rope 40 from the inside wall face 44A of the wire guide groove 44 of the wire guide 42 has the same magnitude as the reaction force applied to the other wire rope 40 from the inside wall face 44A of the wire guide groove 44 of the wire guide 42. This enables the reaction force from the inside wall face 44A of the wire guide groove 44 when the wire ropes 40 are pulled toward their length direction leading end side to be retained (received) by each wire rope 40.

Since the reaction force from the inside wall face 44A of the wire guide groove 44 when the wire ropes 40 are pulled toward their length direction leading end side can be retained by each wire rope 40 in this manner, the diameter dimension of each wire rope 40 can be made shorter than in configuration in which reaction force from the inside wall face 44A of the wire guide groove 44 is borne (received) by a single wire rope. This enables the buckle device 10 to be reduced in size.

In the present exemplary embodiment, the inside wall face 44A of the wire guide groove 44 of the wire guide 42 is configured as a face parallel to the vehicle width direction (the width direction of the seat 14), whereas the outside wall face 44B of the wire guide groove 44 of the wire guide 42 is sloped at a specific angle θ toward the outer side of the bent portions of the wire ropes 40 with respect to the open direction side of the wire guide groove 44 (the vehicle width direction inside). Thus, in the wire guide groove 44 of the wire guide 42, a spacing between the inside wall face 44A and the outside wall face 44B of the wire guide groove 44 increases on progression toward the open side (vehicle width direction inside) of the wire guide groove 44. This enables that when opening a mold for forming the wire guide 42, a portion (core) of the mold, forming the wire guide groove 44, to be easily removed from the wire guide groove 44.

Note that the present exemplary embodiment is configured including two wire ropes 40 as moving members. However, three or more wire ropes 40 may be provided as moving members. Alternatively, a single belt shaped member with its width direction running along the width direction of the seat 14 may be provided as a moving member. In such a configuration in which a belt shaped member serves as the moving member, the magnitudes of reaction force from the inside wall face 44A of the wire guide groove 44 of the wire guide 42 borne (received) by one side portion in width direction and another side portion in width direction of the belt shaped member can be made the same, thereby enabling equivalent advantageous effects to the advantageous effects in the above-described present exemplary embodiment to be obtained.

What is claimed is:

1. A buckle device comprising:
a buckle that is configured to engage with a tongue of a seatbelt device;
a movement section whose leading end portion in a length direction of the movement section is coupled to the buckle, and that is configured to move along the length direction accompanying the buckle;
a drive section that is driven such that the movement section is moved along the length direction; and
an intermediate member at which an intermediate portion in the length direction of the movement section is bent, and that is capable of suppressing a difference from occurring between curvatures of bending of the intermediate portion at one side and at another side of the movement section in a seat width direction of a seat applied with the seatbelt device, when the movement section abuts the intermediate member.

2. The buckle device of claim 1, wherein when the intermediate portion abuts the intermediate member, the curvatures of the bending of the intermediate portion at the one side and at the another side are the same.

3. The buckle device of claim 1, wherein:
the movement section includes a plurality of moving members disposed side by side in the seat width direction; and
the intermediate member is capable of suppressing a difference from occurring between curvatures of bendings of the plurality of moving members at the intermediate member when the plurality of moving members abut the intermediate member.

4. The buckle device of claim 3, wherein when intermediate portions of the plurality of moving members abut the intermediate member, the curvatures of the bendings of the intermediate portions at the intermediate member are the same.

5. The buckle device of claim 1, wherein an inside wall face at the intermediate member, provided at an inner side of a bent portion of the intermediate portion, is parallel to the seat width direction.

6. The buckle device of claim 2, wherein an inside wall face at the intermediate member, provided at an inner side of a bent portion of the intermediate portion, is parallel to the seat width direction.

7. The buckle device of claim 5, wherein:
the intermediate member includes a groove portion that is open in the seat width direction, and the intermediate portion is bent due to the intermediate portion being disposed at an inside of the groove portion;
the groove portion includes the inside wall face; and
an outside wall face of the groove portion, provided at an outer side of the bent portion of the intermediate portion, is sloped toward the outer side with respect to an opening direction of the groove portion.

8. The buckle device of claim 6, wherein:
the intermediate member includes a groove portion that is open in the seat width direction, and the intermediate portion is bent due to the intermediate portion being disposed at an inside of the groove portion;
the groove portion includes the inside wall face; and
an outside wall face of the groove portion, provided at an outer side of the bent portion of the intermediate portion, is sloped toward the outer side with respect to an opening direction of the groove portion.
